(19) United States
(12) Patent Application Publication
(10) Pub. No.: US 2011/0007316 A1
(43) Pub. Date: Jan. 13, 2011

(54) Inspection Method and Apparatus, Lithographic Apparatus, Lithographic Processing Cell and Device Manufacturing Method

(75) Inventors: Johannes Matheus Marie DE WIT, Helmond (NL); Arnold Sinke, Veldhoven (NL); Marnix Aldert Tas, Eindhoven (NL); Ronald Franciscus Herman Hugers, Eindhoven (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 12/777,486

(22) Filed: May 11, 2010

Related U.S. Application Data
(60) Provisional application No. 61/178,678, filed on May 15, 2009.

(51) Int. Cl. G01J 4/00

(52) U.S. Cl. 356/365

(57) ABSTRACT

An inspection apparatus configured to measure a property of a substrate includes an illumination source, a beam splitter, a first polarizer positioned between the illumination source and the beam splitter, an objective lens and an optical device that alters a polarization state of radiation traveling through it positioned between the beam splitter and the substrate and a second polarizer positioned between the beam splitter and a detector. An axis of the second polarizer is rotated with respect to an axis of the first polarizer. Radiation polarized by the first polarizer that reflects off any optical elements between the beam splitter and the optical device is prevented from entering the detector by the second polarizer. Only radiation that passes twice through the optical device has its polarization direction rotated so that it passes through the second polarizer and enters the detector.

### CROSS REFERENCE TO RELATED APPLICATIONS

This application claims priority under 35 U.S.C. §119(e) to U.S. Provisional Patent Application No. 61/178,678, filed May 15, 2009, which is incorporated by reference herein in its entirety.

### BACKGROUND

1. Field of the Invention

The present invention relates to inspection apparatuses and methods of inspection usable, for example, in the manufacture of devices by lithographic techniques and to methods of manufacturing devices using lithographic techniques.

2. Background Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to monitor the lithographic process, it is necessary to measure parameters of the patterned substrate, for example the overlay error between successive layers formed in or on it. There are various techniques for making measurements of the microscopic structures formed in lithographic processes, including the use of scanning electron microscopes and various specialized tools. One form of specialized inspection tool is a scatterometer in which a beam of radiation is directed onto a target on the surface of the substrate and properties of the scattered or reflected beam are measured. By comparing the properties of the beam before and after it has been reflected or scattered by the substrate, the properties of the substrate can be determined. This can be done, for example, by comparing the reflected beam with data stored in a library of known measurements associated with known substrate properties. Two main types of scatterometer are known. Spectroscopic scatterometers direct a broadband radiation beam onto the substrate and measure the spectrum (intensity as a function of wavelength) of the radiation scattered into a particular narrow angular range. Angularly resolved scatterometers use a monochromatic radiation beam and measure the intensity of the scattered radiation as a function of angle.

In a scatterometer a high NA objective lens is used to project radiation onto a substrate. One problem for such scatterometers is that the focus depth of a high NA objective lens is small. This makes it difficult to accurately perform the measurements in a short time.

### SUMMARY

It is desirable to provide a method and apparatus to satisfactorily measure the focus of a scatterometer.

According to an embodiment of the present invention, there is provided an inspection apparatus, lithographic apparatus or lithographic cell configured to measure a property of a substrate comprising an illumination source; a beam splitter; a first polarizer positioned in a first optical path that optically connects the illumination source to the beam splitter; an objective lens positioned in a second optical path that optically connects the beam splitter to the substrate; an optical device that is configured to alter a polarization state of radiation traveling through it positioned in the second optical path; a detector; and a second polarizer positioned in a third optical path that connects the beam splitter to the detector. An axis of the second polarizer is rotated with respect to an axis of the first polarizer.

According to a further embodiment of the present invention, there is provided a method of measuring a property of a patterned target on a substrate, or a device manufacturing method, comprising the following steps. Projecting a beam of radiation. Transmitting the radiation through a first polarizer. Reflecting the radiation towards the patterned target. Altering a polarization state of the radiation. Focusing the radiation onto the patterned target. Altering a polarization state of the radiation reflected from the patterned target. Passing the radiation through a second polarizer. Measuring the radiation reflected from the patterned target. An axis of the second polarizer is rotated with respect to an axis of the first polarizer.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

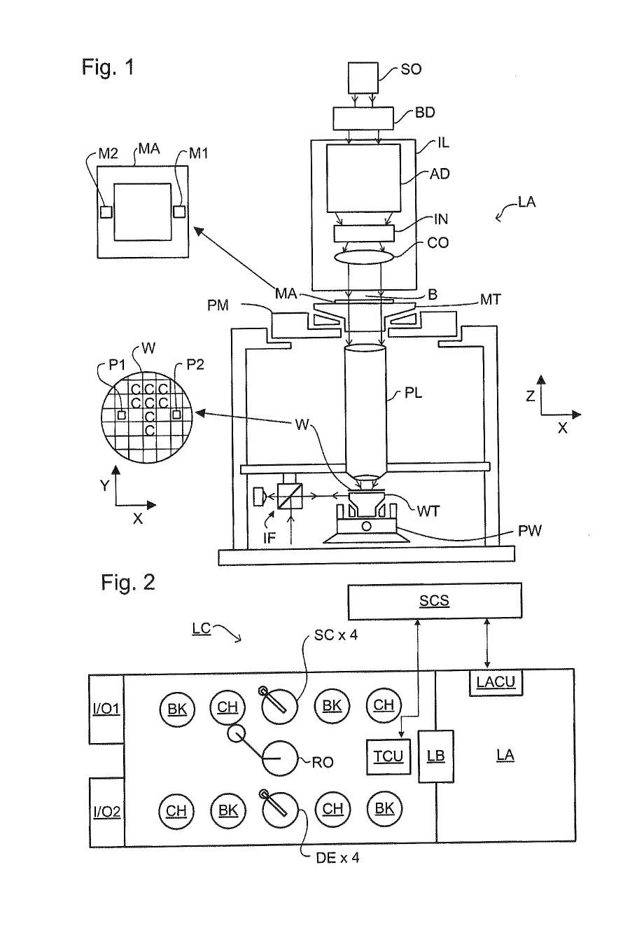

FIG. 1 depicts a lithographic apparatus.

FIG. 2 depicts a lithographic cell or cluster.

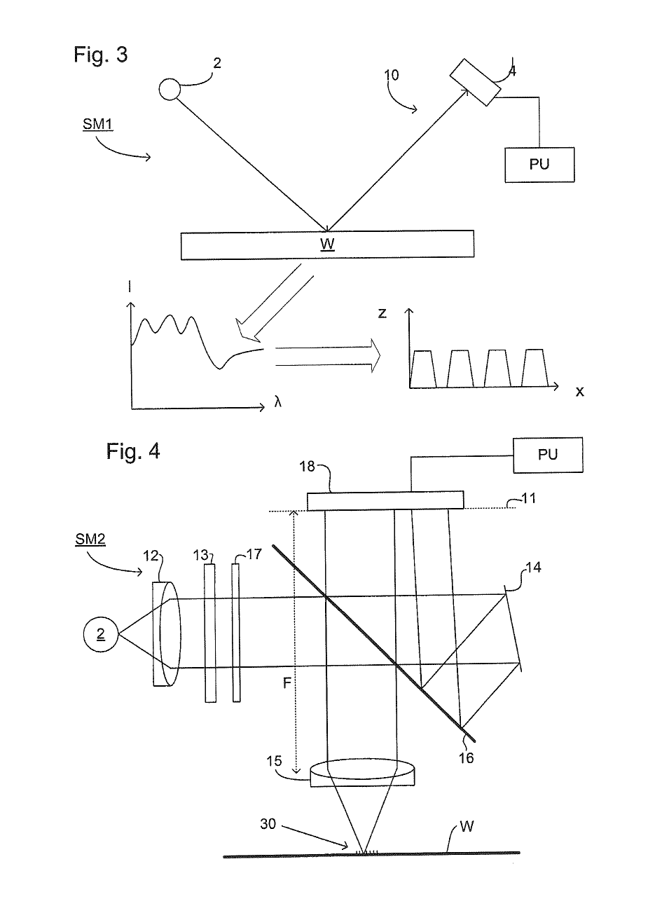

FIG. 3 depicts a first scatterometer.

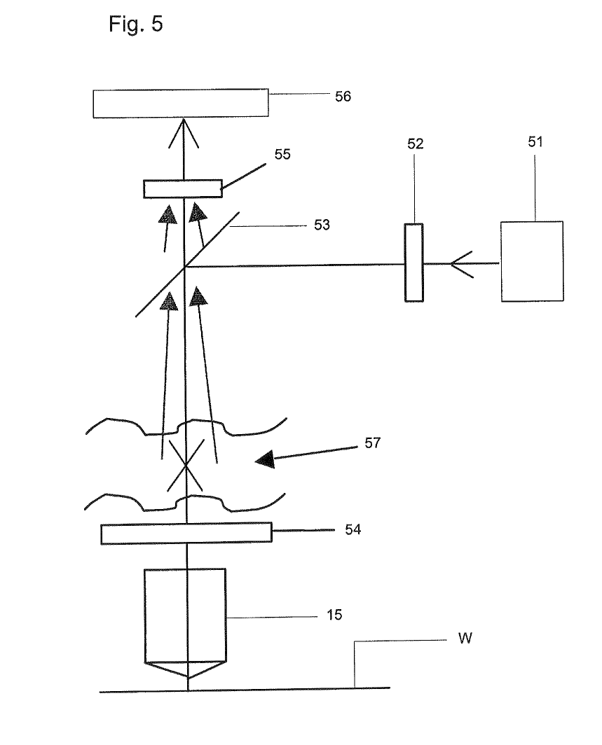

FIG. 4 depicts a second scatterometer.

FIG. 5 depicts a system of an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

FIG. 1 schematically depicts a lithographic apparatus. The apparatus comprises: an illumination system (illuminator) IL configured to condition a radiation beam B (e.g., UV radiation or DIV radiation); a support structure (e.g., a mask table) MT constructed to support a patterning device (e.g., a mask) MA and connected to a first positioner PM configured to accurately position the patterning device in accordance with certain parameters; a substrate table (e.g., a wafer table) WT constructed to hold a substrate (e.g., a resist-coated wafer) W and connected to a second positioner PW configured to accurately position the substrate in accordance with certain parameters; and a projection system (e.g., a refractive projection lens system) PL configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PL, which focuses the beam onto a target portion C of the substrate W. With the aid of the second positioner PW and position sensor IF (e.g., an interferometric device, linear encoder, 2-D encoder or capacitive sensor), the substrate table WT can be moved accurately, e.g., so as to position different target portions C in the path of the radiation beam B. Similarly, the first positioner PM and another position sensor (which is not explicitly depicted in FIG. 1) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e., a single dynamic exposure). The velocity and direction of the substrate table WT relative to the mask table MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 2, the lithographic apparatus LA forms part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers then to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between subsequent layers, line thicknesses, critical dimensions (CD), etc. If errors are detected, adjustments may be made to exposures of subsequent substrates, especially if the inspection can be done soon and fast enough that other substrates of the same batch are still to be exposed. Also, already exposed substrates may be stripped and reworked—to improve yield—or discarded—thereby avoiding performing exposures on substrates that are known to be faulty. In a case where only some target portions of a substrate are faulty, further exposures can be performed only on those target portions that are good.

An inspection apparatus is used to determine the properties of the substrates, and in particular, how the properties of different substrates or different layers of the same substrate vary from layer to layer. The inspection apparatus may be integrated into the lithographic apparatus LA or the lithocell LC or may be a stand-alone device. To enable most rapid measurements, it is desirable that the inspection apparatus measure properties in the exposed resist layer immediately after the exposure. However, the latent image in the resist has a very low contrast—there is only a very small difference in refractive index between the parts of the resist that have been exposed to radiation and those that have not—and not all inspection apparatus have sufficient sensitivity to make useful measurements of the latent image. Therefore measurements may be taken after the post-exposure bake step (PEB), which is customarily the first step, carried out on exposed substrates and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibilities for rework of faulty substrates but may still provide useful information.

FIG. 3 depicts a scatterometer SM1, which may be used in the present invention. It comprises a broadband (white light) radiation projector 2, which projects radiation onto a substrate W. The reflected radiation is passed to a spectrometer detector 4, which measures a spectrum 10 (intensity as a function of wavelength) of the specular reflected radiation. From this data, the structure or profile giving rise to the detected spectrum may be reconstructed by processing unit PU, e.g., by Rigorous Coupled Wave Analysis and non-linear regression or by comparison with a library of simulated spectra as shown at the bottom of FIG. 3. In general, for the reconstruction the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer.

Another scatterometer SM2 that may be used with the present invention is shown in FIG. 4. In this device, the radiation emitted by radiation source 2 is focused using lens system 12 through interference filter 13 and polarizer 17, reflected by partially reflective surface 16 and is focused onto substrate W via a microscope objective lens 15, which has a high numerical aperture (NA), preferably at least 0.9 and more preferably at least 0.95. Immersion scatterometers may even have lenses with numerical apertures over 1. The reflected radiation then transmits through partially reflective surface 16 into a detector 18 in order to have the scatter spectrum detected. The detector may be located in the back-projected pupil plane 11, which is at the focal length of the lens system 15, however the pupil plane may instead be re-imaged with auxiliary optics (not shown) onto the detector. The pupil plane is the plane in which the radial position of radiation defines the angle of incidence and the angular position defines azimuth angle of the radiation. The detector is preferably a two-dimensional detector so that a two-dimensional angular scatter spectrum of a substrate target 30 can be measured. The detector 18 may be, for example, an array of CCD or CMOS sensors, and may use an integration time of, for example, 40 milliseconds per frame.

A reference beam is often used for example to measure the intensity of the incident radiation. To do this, when the radiation beam is incident on the beam splitter 16 part of it is transmitted through the beam splitter as a reference beam towards a reference mirror 14. The reference beam is then projected onto a different part of the same detector 18.

A set of interference filters 13 is available to select a wavelength of interest in the range of, say, 405-790 nm or even lower, such as 200-300 nm. The interference filter may be tunable rather than comprising a set of different filters. A grating could be used instead of interference filters.

The detector 18 may measure the intensity of scattered light at a single wavelength (or narrow wavelength range), the intensity separately at multiple wavelengths or integrated over a wavelength range. Furthermore, the detector may separately measure the intensity of transverse magnetic- and transverse electric-polarized light and/or the phase difference between the transverse magnetic- and transverse electric-polarized light.

Using a broadband light source (i.e., one with a wide range of light frequencies or wavelengths—and therefore of colors) is possible, which gives a large etendue, allowing the mixing of multiple wavelengths. The plurality of wavelengths in the broadband preferably each has a bandwidth of δλ and a spacing of at least 2 δλ (i.e., twice the bandwidth). Several “sources” of radiation can be different portions of an extended radiation source that have been split using fiber bundles. In this way, angle resolved scatter spectra can be measured at multiple wavelengths in parallel. A 3-D spectrum (wavelength and two different angles) can be measured, which contains more information than a 2-D spectrum. This allows more information to be measured which increases metrology process robustness. This is described in more detail in EP 1 628 164 A.

The target 30 on substrate W may be a grating, which is printed such that after development, the bars are formed of solid resist lines. The bars may alternatively be etched into the substrate, or deposited as contrast enhancing material such as a metal having high reflectivity, or carbon having low reflectivity. This pattern is sensitive to chromatic aberrations in the lithographic projection apparatus, particularly the projection system PL, and illumination symmetry and the presence of such aberrations will manifest themselves in a variation in the printed grating. Accordingly, the scatterometry data of the printed gratings is used to reconstruct the gratings. The parameters of the grating, such as line widths and shapes, may be input to the reconstruction process, performed by processing unit PU, from knowledge of the printing step and/or other scatterometry processes.

In a scatterometer a high NA objective lens is used to project light on a wafer. The focus depth of a high NA objective lens may be small. Therefore, in order to enable detection of whether the scatterometer SM is properly focused, a focus detection branch is provided. The focus detection branch comprises an illumination source 51 configured to produce a focus measurement beam of radiation, a beam splitter 53 to divert a portion of the focus measurement beam through the objective lens 15 of the scatterometer, and a focus detector 56 in the path of the focus measurement beam after reflection from the substrate W. In this way, a focus sensor is integrated into the scatterometer.

The focus sensor generates a focus error signal that indicates whether the objective lens is in focus or not. It is possible to provide a focus sensor that shares a common illumination source with the main measurement branch of the scatterometer. However, in order to improve the signal to noise ratio of the focus measurement beam, it is desirable for the focus sensor to have an illumination source 51 that is separate from that of the main measurement beam.

Optionally, the illumination source 51 of the focus sensor is a laser. Other suitable illumination sources for the focus sensor include a light emitting diode or a superluminescent light emitting diode.

Optionally, the wavelength of focus illumination is limited to the range of wavelengths used for the main measurement branch of the scatterometer. This may be done in order to reduce any chromatic aberration. Alternatively, the wavelength of focus illumination may be different from that used for the main measurement branch, for example in order to enhance the focus measurement of the substrate.

The beam splitter 53 of the focus detection branch reflects radiation from the focus sensor illumination source 51 towards the objective lens 15. The radiation is projected through the objective lens 15 onto the substrate W. A portion of the radiation is reflected at the substrate surface and passes again through the objective lens 15 and the beam splitter 53 and enters the focus detector 56.

Optical component(s) 57 for purposes such as substrate parameter measurements may be positioned in the optical path that connects the beam splitter 53 of the focus detection branch to the objective lens 15. For example, there may another beam splitter for diverting radiation into another branch of the scatterometer.

When the radiation from the focus sensor illumination source 51 passes through these optical component(s) 57, there may be unwanted reflections from the optical component(s) 57. If the unwanted reflected light impinges on the focus detector 56, undesirable offsets in the focus error signals may be produced. Variation in the intensity of the focus illumination source leads to varying offsets of intensity detected on the focus detector. Coupled with the impinging unwanted reflected light, it is difficult to compensate for the varying offsets by calibration. This leads to an erroneous focus signal. Additionally, saturation of the focus detector 56 by the unwanted reflected light prevents focus detection. Ultimately, this has the result that the objective lens 15 will not be in focus.

One way to improve the focus measurement is to reduce the amount of radiation that enters the focus detector 56 after being undesirably reflected on the optical path between the beam splitter 53 of the focus detection branch and the objective lens 15.

FIG. 5 depicts a system of an embodiment of the present invention. In this example, a first polarizer 52 is positioned on the optical path between the illumination source 51 and beam splitter 53 of the focus detection branch. Optionally, the first polarizer 52 is positioned directly after the illumination source 51.

In this example, the first polarizer 52 linearly polarizes radiation from the illumination source 51. The polarization direction may be, for example, S-polarized radiation or P-polarized radiation. For ease of explanation, it will be taken that the radiation that is transmitted by the first polarizer 52 is S-polarized radiation. The beam splitter 53 reflects this S-polarized radiation along the optical path between the beam splitter 53 and the objective lens 15.

In this example, an optical device 54 that is configured to alter a polarization state of radiation traveling through it is positioned in the optical path between the beam splitter 53 and the substrate W. Optionally, the optical device 54 is a quarter-wave plate. Alternatively, the optical device 54 may be an optical polarization modulator.

An example of an optical polarization modulator is a photoelastic modulator. A photoelastic modulator comprises a piezoelectric element and a piece of transparent material, for example fused silica. The transducer is tuned to the natural frequency of the piece of transparent material. When the piezoelectric element is actuated, it strains the transparent material. This has the effect of altering the birefringence of the transparent material. This means that radiation that passes through the transparent material will have its polarization state altered. Effectively, the modulator is a tunable wave plate.

For ease of explanation, embodiments of the invention will be described with reference to a quarter-wave plate.

Optionally, the quarter-wave plate is a zero-order wave plate. This means that the relative phase imparted on perpendicular polarization components of the radiation is a quarter wavelength, rather than a quarter plus a whole number of wavelengths. The purpose of this is to minimize dispersion such that the quarter-wave plate introduces the quarter-wave phase shift for radiation over a wide range of wavelengths. Optionally, the quarter-wave plate is achromatic. The quarter-wave plate may be made of a birefringent material such as quartz, MgF₂, CaF₂ or calcite, for example.

As mentioned above, there are optical components 57, other than the quarter-wave plate 54, in the optical path between the beam splitter 53 and the objective lens 15. The quarter-wave plate 54 is positioned in the optical path between these optical components 57 and the objective lens 15. The quarter wave plate 54 transforms the linearly S-polarized radiation into circularly polarized radiation. The circularly polarized radiation is transmitted by the objective lens 15 and is reflected at the substrate surface W. The circularly polarized radiation then passes back through the objective lens 15 and the quarter wave plate 54. The quarter wave plate 54 transforms the circularly polarized radiation back into linearly polarized radiation.

However, the polarization direction of the reflected radiation that has passed twice through the quarter-wave plate 54 is rotated substantially 90 degrees with respect to the polarization direction of the radiation transmitted by the first polarizer 52. Hence, if the first polarizer 52 transmitted S-polarized radiation, the radiation that has passed twice through the quarter-wave plate 54 and been reflected at the substrate surface W will be linearly P-polarized radiation.

The P-polarized radiation is transmitted through the beam splitter 53. A second polarizer 55 is positioned in the optical path between the beam splitter 53 and the focus detector 56. The P-polarized radiation passes through the second polarizer 55 and enters the focus detector 56. In this way, radiation that has been reflected at the substrate surface W enters the focus detector, enabling focus measurement of the scatterometer.

A portion of the S-polarized radiation may be undesirably reflected by one or more optical components 57 that are in the optical path between the beam splitter 53 and the quarter wave plate 54. This stray reflected radiation does not pass through the quarter wave plate 54. Therefore, the polarization direction remains as S-polarization.

As a result, this undesirably reflected radiation is blocked by the second polarizer 55 and does not enter the focus detector 56. In this way, the intensity of the undesirably reflected radiation that enters the focus detector 56 is reduced. The reduction can be by a factor of 1000 to 10000 depending on the design of the polarizers 52, 55.

Any radiation that is reflected by an optical element positioned in the optical path between the quarter wave plate 54 and the substrate W will pass twice through the quarter wave plate and enter the detector. Therefore, it is desirable to minimize the optical elements between the quarter wave plate 54 and the substrate W. Optionally, the quarter wave plate is positioned between the beam splitter and the objective lens 15, directly adjacent to the objective lens 15. In this way there are no optical elements between the quarter wave plate 54 and the objective lens 15 that will reflect light that enters the detector 56.

Optionally, there are optics positioned between the quarter wave plate 54 and the objective lens 15. In this embodiment, the full benefit of the present invention is not achieved because stray light reflected by these optics will undesirably enter the detector 56. However, benefit is still achieved by blocking radiation reflected by optics between the beam splitter 53 and the quarter wave plate 54.

Optionally, the first and second polarizers 52, 55 are selected from the group consisting of a beam-splitting polarizer, a polarizing plate and a polarizing mirror. The polarizers are wide band polarizers. This means that they polarize radiation of a wide range of wavelengths.

Optionally, the beam splitter 53 has a coating that transmits more than 50% of P-polarized radiation and reflects more than 50% of S-polarized radiation.

As explained above, embodiments of the present invention have been described with reference to S- and P-polarized radiation for ease of explanation. The polarization direction of each the polarizers may be varied provided that there is a difference between the axes of the first polarizer 52 and the second polarizer 55. Optionally, an axis of the first polarizer 52 is rotated substantially 90 degrees with respect to an axis of the second polarizer 55.

Optionally, an optical axis of the quarter-wave plate 54 is rotated substantially 45 degrees with respect to the axes of the first and second polarizers 52, 55. However, the angle may vary, for example by 2 degrees, from 45 degrees.

Although specific reference may be made in this text to embodiments of the present invention applied to a focus detection branch of a scatterometer, the present invention may be applied to branches of a scatterometer other than a focus detection branch.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 355, 248, 193, 157 or 126 nm) and extreme ultra-violet (EUV) radiation (e.g., having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1-7. (canceled)

8. The inspection apparatus according to claim 20, wherein:
the beam splitter is a polarizing beam splitter having a coating that has a higher transmission coefficient for light that is linearly polarized in a first direction than for light that is linearly polarized in a second direction that is substantially 90 degrees rotated with respect to the first direction.

9. The inspection apparatus according to claim 20, wherein:
the inspection apparatus further comprises an optical element positioned in the second optical path; and
the optical device is positioned in a section of the second optical path between the optical element and the substrate.

10. The inspection apparatus according to claim 9, wherein the optical element is another beam splitter.

11. The inspection apparatus according to claim 9, wherein the optical element is a mirror.

12. The inspection apparatus according to claim 9, wherein the optical element is another lens.

13. The inspection apparatus according to claim 20, wherein the objective lens has a numerical aperture of at least 0.95.

14. The inspection apparatus according to claim 20, wherein the detector is a focus detector.

15. The inspection apparatus according to claim 20, wherein the illumination source, the beam splitter, the first and second polarizers, the optical device and the detector are comprised in a focus sensing branch of the inspection apparatus.

16. A lithographic apparatus comprising:
an illumination optical system arranged to illuminate a pattern;
a projection optical system arranged to project an image of the pattern onto a substrate; and
an angularly resolved scatterometer configured to measure a property of a substrate, the scatterometer comprising:
an illumination source;
a beam splitter;
a first polarizer positioned in a first optical path that optically connects the illumination source to the beam splitter;
an objective lens positioned in a second optical path that optically connects the beam splitter to the substrate;
an optical device that is configured to alter a polarization state of radiation traveling through it positioned in the second optical path;
a detector; and
a second polarizer positioned in a third optical path that connects the beam splitter to the detector;
wherein an axis of the second polarizer is rotated with respect to an axis of the first polarizer.

17. A lithographic cell comprising:
a coater arranged to coat substrates with a radiation sensitive layer;
a lithographic apparatus arranged to expose images onto the radiation sensitive layer of substrates coated by the coater;
a developer arranged to develop images exposed by the lithographic apparatus; and
an angularly resolved scatterometer configured to measure a property of a substrate, the scatterometer comprising:
an illumination source;
a beam splitter;
a first polarizer positioned in a first optical path that optically connects the illumination source to the beam splitter;
an objective lens positioned in a second optical path that optically connects the beam splitter to the substrate;
an optical device that is configured to alter a polarization state of radiation traveling through it positioned in the second optical path;
a detector; and
a second polarizer positioned in a third optical path that connects the beam splitter to the detector;
wherein an axis of the second polarizer is rotated with respect to an axis of the first polarizer.

18. A method of measuring a property of a patterned target on a substrate, comprising:
projecting a beam of radiation;
transmitting the radiation through a first polarizer;
reflecting the radiation towards the patterned target;
altering a polarization state of the radiation;
focusing the radiation onto the patterned target;
altering a polarization state of the radiation reflected from the patterned target;
passing the radiation through a second polarizer; and
measuring the radiation reflected from the patterned target,
wherein an axis of the second polarizer is rotated with respect to an axis of the first polarizer.

19. A device manufacturing method comprising:
using a lithographic apparatus to form a pattern on a substrate; and
determining a value related to a parameter of the pattern printed by:
projecting a beam of radiation;
transmitting the radiation through a first polarizer;
reflecting the radiation towards the patterned target;
altering a polarization state of the radiation;
focusing the radiation onto the patterned target;
altering a polarization state of the radiation reflected from the patterned target;
passing the radiation through a second polarizer; and
measuring the radiation reflected from the patterned target,
wherein an axis of the second polarizer is rotated with respect to an axis of the first polarizer.

20. An inspection apparatus configured to measure a property of a substrate, comprising:
an illumination source;
a beam splitter;
a first polarizer positioned in a first optical path configured to optically connect the illumination source to the beam splitter;
an objective lens positioned in a second optical path configured to optically connect the beam splitter to the substrate;
an optical device that is configured to alter a polarization state of radiation traveling through it positioned in the second optical path;
a detector; and
a second polarizer positioned in a third optical path configured to connect the beam splitter to the detector;
wherein an axis of the second polarizer is rotated with respect to an axis of the first polarizer.

21. The inspection apparatus according to claim 20, wherein an optical axis of the optical device is rotated substantially 45 degrees with respect to an axis of the first and second polarizers.

22. The inspection apparatus according to claim 20, wherein:
the first and second polarizers are linear polarizers; and
an axis of the second polarizer is rotated substantially 90 degrees with respect to an axis of the first polarizer.

23. The inspection apparatus according to claim 20, wherein the first polarizer is a beam-splitting polarizer, a polarizing plate or a polarizing mirror.

24. The inspection apparatus according to claim 20, wherein the second polarizer is a beam-splitting polarizer, a polarizing plate or a polarizing mirror.

25. The inspection apparatus according claim 20, wherein the optical device is a quarter-wave plate.

26. The inspection apparatus according to claim 20, wherein the optical device is an optical polarization modulator.

27-30. (canceled)
